(19) United States
(12) Patent Application Publication
(10) Pub. No.: US 2010/0255742 A1
(43) Pub. Date: Oct. 7, 2010

(54) Heat Radiation Substrate and Illumination Module Substrate Having Hybrid Layer

(76) Inventors: Geum Hee YUN, Gyunggi-do (KR); Jun Rok OH, Seoul (KR); Sang Jun YOON, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/501,858

(22) Filed: Jul. 13, 2009

(30) Foreign Application Priority Data
Apr. 6, 2009 (KR) 10-2009-0029592

(51) Int. Cl. B32B 27/04; B32B 15/00; B32B 27/00; B32B 27/20; B32B 15/09; B32B 15/08

(52) U.S. Cl. 442/117; 428/457; 428/422; 428/446; 428/458; 428/460; 977/742

(57) ABSTRACT

Disclosed is a heat radiation substrate, which includes a hybrid layer made of a thermoplastic resin, in particular, a liquid crystal polymer, and thus is lightweight and small thanks to the inherent properties of plastic and also is able to be mass produced, thus reducing the material and process costs.

### CROSS REFERENCE TO RELATED APPLICATION

This application claims the benefit of Korean Patent Application No. 10-2009-0029592, filed on Apr. 6, 2009, entitled “Substrate for illumination and substrate having good heat radiation property comprising a hybrid layer”, which is hereby incorporated by reference in its entirety into this application.

### BACKGROUND OF THE INVENTION

1. Technical Field

The present invention relates to a heat radiation substrate, and more particularly, to a heat radiation substrate having a thermoplastic resin.

2. Description of the Related Art

As parts which are mounted on a wired substrate are manufactured to be highly dense, highly integrated, lightweight, slim and small, heat radiation properties of the wired substrate greatly affect product reliability. Thus, a part-mounting wired substrate having improved heat radiation performance must be developed.

In particular, as for a light-emitting diode (LED) package substrate, the substrate itself should have high heat radiation performance. Because an LED, which is a device having low luminance, low voltage and a long lifespan and which emits light using the potential difference, is semi-permanently usable and has low power consumption, it is widely applied to signboards, displays, vehicles, signal lamps, backlight units, general illuminators and so on, and is being continuously promoted in all application fields which use them. Furthermore, LEDs are recently receiving attention as illumination light sources to be used in place of fluorescent lamps or incandescent light bulbs.

As such, an illumination LED requires high light capacity, high efficiency and a large area, and an LED package should have high heat radiation properties and reliability and should be lightweight, slim, short and small. Accordingly, in order to spread an illumination LED, the development of an inexpensive LED package platform able to reduce the material and process costs is essential.

FIG. 1 shows a conventional LED package 10 including a lead frame 13, and FIG. 2 shows the cross-section of a general metal substrate in the conventional LED package.

The conventional LED package 10 is manufactured by forming a housing 12 made of a polymer insulating material on the lead frame 13 which is a basic structure of a high-output LED package 10, disposing a heat sink 16 for heat transfer in the housing 12, mounting an LED chip 11 on the heat sink 16, forming a wirebonding 18 for chip connection, introducing a silicon molding 15, and mounting a lens 14.

The conventional high-output LED package 10 is formed of various materials and has a complicated structure, and thus the number of processes is increased, undesirably raising the material cost, the process cost and the production time, resulting in poor productivity. Furthermore, because the LED package is provided in the form of individual package units due to its complicated structure, it is difficult to reduce the size of the individual packages and also to manufacture a multi-module having a plurality of packages.

As shown in FIG. 2, the conventional metal substrate is simply configured such that a circuit layer 25, an insulating layer 23 and a metal layer 21 are sequentially formed downwards from an upper direction. The circuit layer 25 is formed mainly of copper, and the insulating layer is formed of epoxy resin or ceramic filler-containing epoxy resin. The metal layer 21 is formed of aluminum which is relatively inexpensive. In this case, because aluminum at least about 1.5 mm thick should be used, the weight thereof is undesirably increased.

Furthermore, in the case where the thickness of aluminum is decreased in accordance with the ongoing trend of weight reduction, hardness is lowered and thus deformation or warping at high temperature may result. Also, because aluminum has poor chemical resistance, protective tape should be attached thereto upon circuit formation, which is cumbersome.

Moreover, the total material cost of the LED package is increased attributable to the use of the expensive lead frame. Also, because of the weight of the lead frame itself, the LED package is difficult to apply to an illuminator which is required to be lightweight, slim, short and small.

Therefore, an LED package using low temperature co-fired ceramic (LTCC) in lieu of the lead frame has been developed. This package is advantageous because a plurality of ceramic sheets may be stacked using a conventional LTCC process for the construction of a package module, but the material cost of the ceramic substrate is high. Furthermore, upon fabrication of a substrate for mounting a plurality of LEDs, a danger of causing crack may increase in proportion to the increase in the size of the substrate, thus making it impossible to enlarge the area of the substrate. Moreover, because the coefficient of thermal expansion of the ceramic substrate is different from that of the molding resin, interfacial delamination may occur at high temperature, undesirably resulting in poor reliability.

### SUMMARY OF THE INVENTION

Therefore, the present invention has been made keeping in mind the problems encountered in the related art and provides a heat radiation substrate, which is lightweight, slim, short and small and has high reliability and processability and a large area, with reduced material and process costs, thanks to the use of a plastic substrate having high thermal conductivity to improve heat radiation properties.

An aspect of the present invention provides a heat radiation substrate having a hybrid layer, including a hybrid layer including a thermoplastic polymer and a conductive filler, an insulating layer formed on the hybrid layer, and a metal layer formed on the insulating layer.

In the heat radiation substrate, the insulating layer may include a thermoplastic polymer and a thermally conductive ceramic filler.

In the heat radiation substrate, the thermoplastic polymer of the hybrid layer may be any one selected from the group consisting of a liquid crystal polymer (LCP), polyetheretherketone (PEEK), polyetherimide (PEI), polyethersulfone (PES) and polytetrafluoroethylene (PTFE).

In the heat radiation substrate, the conductive filler may be one or more selected from the group consisting of a carbonaceous filler, metallic powder, a metal oxide-based filler and a conductive coating filler.

The heat radiation substrate may further include a via for connecting the metal layer and the hybrid layer to each other.

In the heat radiation substrate, the thermally conductive ceramic filler may be crystalline silica (SiO₂), fused silica (SiO₂), silicon nitride (SiN), boron nitride (BN), aluminum nitride (AlN) or alumina (Al₂O₃), or is a heterogeneous mixture of fillers having different thermal conductivities and shapes.

In the heat radiation substrate, the thermoplastic polymer of the insulating layer may be any one selected from the group consisting of a liquid crystal polymer (LCP), polyetheretherketone (PEEK), polyetherimide (PEI), polyethersulfone (PES) and polytetrafluoroethylene (PTFE).

In the heat radiation substrate, the insulating layer may be a prepreg formed by impregnating a woven fabric with a liquid crystal polymer (LCP) resin, as the thermoplastic polymer, containing the thermally conductive ceramic filler.

In the heat radiation substrate, the carbonaceous filler may be carbon black, graphite powder, carbon fiber or carbon nanotubes.

In the heat radiation substrate, the metallic powder may be gold, silver, platinum, copper, or aluminum powder.

In the heat radiation substrate, the woven fabric may be E-glass, D-glass, S-glass or aramid fiber.

The features and advantages of the present invention will be more clearly understood from the following detailed description taken in conjunction with the accompanying drawings.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

### BRIEF DESCRIPTION OF THE DRAWINGS

FIG. 1 is a schematic view showing a conventional LED package including a lead frame;

FIG. 2 is a cross-sectional view showing a general metal substrate in the conventional LED package;

FIG. 3 is a cross-sectional view showing a heat radiation substrate having a hybrid layer according to an embodiment of the present invention; and

FIG. 4 is a cross-sectional view showing a heat radiation substrate having a hybrid layer according to another embodiment of the present invention.

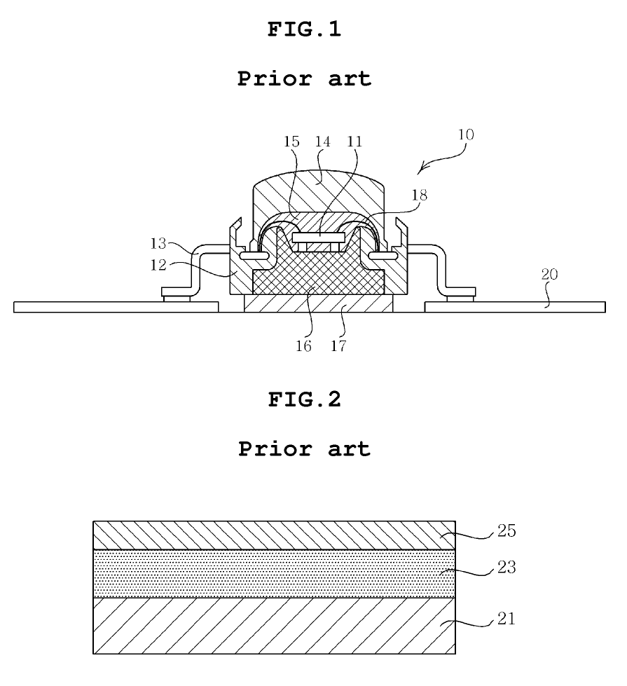

### DESCRIPTION OF THE PREFERRED EMBODIMENTS

Hereinafter, a detailed description will be given of a heat radiation substrate having a hybrid layer according to embodiments of the present invention, with reference to the accompanying drawings. Throughout the drawings, the same reference numerals refer to the same or similar elements, and redundant descriptions are omitted.

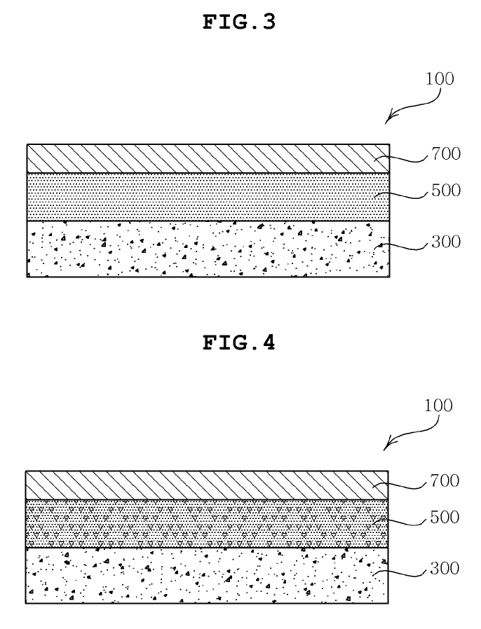

FIG. 3 is a cross-sectional view showing a heat radiation substrate having a hybrid layer according to an embodiment of the present invention. As shown in FIG. 3, the heat radiation substrate having a hybrid layer according to the embodiment of the present invention includes a hybrid layer 300, an insulating layer 500 and a metal layer 700.

The hybrid layer 300 used in the present embodiment is composed of a thermoplastic polymer and a conductive filler.

The thermoplastic polymer consists of a material satisfying high heat resistance in line with the heat occurring upon operation of an LED and mechanical strength sufficiently high to substitute for the lead frame of an LED package. The thermoplastic polymer of the hybrid layer 300 may be a liquid crystal polymer (LCP) having high heat resistance, or may be any one high functional engineering plastic selected from the group consisting of polyetheretherketone (PEEK), polyetherimide (PEI), polyethersulfone (PES) and polytetrafluoroethylene (PTFE).

As the thermoplastic polymer of the hybrid layer 300, particularly useful is an LCP resin which is inexpensive and has high heat resistance and strength. The LCP resin has excellent heat resistance, high stiffness, dimensional stability, and formability.

Furthermore, the thermoplastic polymer is combined with the conductive filler which is one or more selected from the group consisting of a carbonaceous filler, metallic powder, a metal oxide-based filler, and a conductive coating filler. Examples of the carbonaceous filler may include carbon black, graphite powder, carbon fiber, and carbon nanotubes, and examples of the metallic powder may include gold, silver, platinum, copper and aluminum powder. By combining various filler structures, the total thermal conductivity of the system may be improved. As such, woven fabric such as E-glass, D-glass, S-glass or aramid fiber may be used.

The hybrid layer 300 may be formed by directly casting the mixture of thermoplastic LCP which is easily subjected to casting or pressing and conductive filler on the insulating layer 500. Alternatively, the hybrid layer may be formed by processing the above mixture into the form of a film and then pressing it, or by processing the above mixture into powder and then compacting it using a mold under heat and pressure. In this way, the hybrid layer may be manufactured through various methods.

The compaction under high temperature and high pressure may be performed in the same manner as in a conventional ceramic sintering process, such that LCP powder may be bonded through intermolecular necking thus forming a dense structure. Accordingly, the LCP hybrid layer 300 is much lighter than the metal layer 21 of the conventional metal substrate, and furthermore, has chemical resistance superior to that of a material such as for example aluminum.

Also, the process of manufacturing an LCP powder pressed body under high temperature and high pressure using a press is advantageous because an LCP structure which exhibits the same heat resistance and strength as those of a conventional structure may be manufactured at a process cost lower than that of a conventional process of injection molding a thermoplastic polymer. Furthermore, the substrate having a large area may be mass produced thanks to the inherent properties of plastic, thus reducing the material cost and improving the productivity.

The insulating layer 500 used in the present embodiment is provided on the hybrid layer 300, so that the hybrid layer 300 and the metal layer 700 are electrically insulated from each other. The insulating layer 500 is made of an electrically insulating polymer material such as is typically used in a printed circuit board, and examples of such a polymer material include epoxy resin, modified epoxy resin, bisphenol A resin, epoxy-novolac resin, and aramid-, glass fiber- or paper-reinforced epoxy resin.

In order to improve heat radiation performance of the heat radiation substrate 100, as shown in FIG. 4, an insulating layer 500 including a thermoplastic polymer and a thermally conductive ceramic filler may be used.

The thermoplastic polymer of the insulating layer 500 may be LCP having high heat resistance, or may be any one engineering plastic selected from the group consisting of PEEK, PEI, PES and PTFE, as used in the hybrid layer 300.

The thermally conductive ceramic filler may be crystalline silica (SiO₂), fused silica (SiO₂), silicon nitride (SiN), boron nitride (BN), aluminum nitride (AlN) or alumina (Al₂O₃), or may be a heterogeneous mixture of fillers having different thermal conductivities and shapes. The thermally conductive ceramic filler may be provided in the shape of a sphere, flake, or whisker. In the case where fillers having various shapes are introduced in the present invention, thanks to the combination of the fillers, the mean free path of electron may be increased due to difference between aspect ratios of the fillers as a factor contributing to thermal conductivity, thus increasing the total thermal conductivity of the system.

In particular, the insulating layer 500 may be a prepreg obtained by impregnating the woven fabric with the LCP resin containing the thermally conductive ceramic filler. Because a conventional epoxy prepreg has very low thermal conductivity, heat occurring from parts and circuits cannot be rapidly transferred to copper. However, when the LCP prepreg containing the thermally conductive filler is used as the insulating layer 500, thermal conductivity becomes very high while exhibiting superior insulating properties between adjacent circuits, so that heat occurring from the mounted parts and the metal layer 700 can be rapidly transferred to the hybrid layer 300 and thus dissipated.

As mentioned above, the hybrid layer 300 and the insulating layer 500 are made of the thermoplastic resin, and the ceramic filler having high conductivity may be added to the thermoplastic resin to improve heat radiation properties, whereby the heat radiation substrate 100 according to the present invention may play a role as a functional package in addition to the simple housing function of a conventional package.

The metal layer 700 used in the present embodiment is formed on the insulating layer 500. For example, when a part such as an LED is mounted, the metal layer may be formed to have wires for supplying electric power to the part. The metal layer 700 may be formed of electrically conductive metal such as gold, silver, copper, nickel or the like.

The heat radiation substrate 100 according to the present embodiment may further include structural heat radiation means such as a heat radiation via or a thermal core.

A better understanding of the present invention may be obtained through the following example which is set forth to illustrate, but is not to be construed as limiting the present invention.

### EXAMPLE

A heat radiation substrate having a hybrid layer with improved heat dissipation performance using a thermoplastic LCP resin containing a thermally conductive filler and a conductive filler was manufactured through the following procedures.

1) BN having a thermal conductivity of 54 W/m·K was mixed with LCP resin, thus manufacturing a prepreg acting as an insulating layer 500.

2) Inexpensive carbon fiber having high electrical and thermal conductivity was impregnated with LCP resin, thus forming a hybrid layer 300. Table 1 below shows the properties of the hybrid layer 300.

3) A metal layer 700 made of copper foil was disposed on the upper surface of the insulating layer 500 and the hybrid layer 300 was disposed on the lower surface of the insulating layer 500, after which pressing was performed.

The thermal conductivity of the heat radiation substrate 100 processed in the form of a sheet was measured. As results, in the case where the prepreg acting as the insulating layer 500 was mixed with 40 wt % of the thermally conductive filler, thermal conductivity was measured to be about 3˜5 W/m·K, which is at least a 10 times increase over the thermal conductivity of 0.3˜0.4 W/m·K when using only the LCP resin. Table 2 below shows the properties of the heat radiation substrate.

TABLE 1
Properties of Alumina and Hybrid Layer

| Properties | Unit | Aluminum | Hybrid Layer |
|---|---|---|---|
| Volume Resistance | Ω-cm | >1 × 10¹⁴ | >3 × 10¹⁶ |
| Dielectric Constant @ 1 MHz | | 9.9 | 3.37 |
| Dissipation Factor @ 1 MHz | | 0.0004 | 0.001 |
| Thermal Conductivity | W/m · K | 15-30 | 12 |
| Coefficient of Thermal | ppm/ | 7 | 8 |
| Expansion | | | |
| Max. Use Temp. | | 1600 | 360 |
| Tensile Strength | MPa | 200 | >250 |
| Tensile Modulus | GPA | 300 | >30 |
| Water Absorption | % | <0.1 | <0.09 |
| Density | g/cc | 3.9 | 2 |

TABLE 2
Properties of Heat Radiation Substrate

| Test Items | Unit | Results | Test Method |
|---|---|---|---|
| Thickness | | | |
| Metal Layer (Copper Foil) | μm | 70 | |
| Insulating layer | mm | 0.2 | |
| (LCP Prepreg) | | | |
| Hybrid Layer (LCP Hybrid) | mm | 0.1 | |
| Thermal Conductivity | W/m · K | Max. 5 | |
| Adhesive Strength | Kg/cm | 2.3 | JIS6471 |
| Heat Resistance | 288 | No | JIS6471 |
| | 30 sec | Delamination | |
| Chemical Resistance | | | |
| 10% Sulfuric Acid | 15 min | No Change | Sight Check |
| | | | after Treatment |
| 10% Sodium Hydroxide | 15 min | No Change | Sight Check |
| | | | after Treatment |
| Dielectric Constant | 3.5 | | 1 MHz |

In the above example, thermoplastic LCP powder having a diameter ranging from ones to tens of μm was used. However, in addition to LCP, a high functional thermoplastic plastic having high heat resistance, such as PEEK and so on, may be used in powder form.

Furthermore, the insulating layer 500 may be formed through a compaction process including stirring the powder mixture including the thermoplastic powder and functional ceramic filler or the powder mixture further including a binder, as necessary, loading a predetermined amount of the stirred powder mixture in a mold and then performing hot pressing, or through an injection molding process including loading a powder mixture melt into a mold and then applying pressure thereto.

The heat radiation substrate 100 according to the present invention includes the hybrid layer 300 made of thermoplastic resin in particular LCP, and thus can be manufactured to be lightweight and small thanks to the inherent properties of plastic and also can reduce the material and process costs through its mass production.

Moreover, because the heat radiation substrate 100 having a composite structure is manufactured using the thermoplastic LCP resin mixed with the filler or fiber having high thermal conductivity, heat radiation performance can be improved and chemical resistance can be enhanced and thus processability is also increased.

In particular, in the case where the heat radiation substrate 100 is applied to a substrate for an illustration module including a plurality of LEDs, heat occurring from the LEDs can be effectively dissipated, thus improving performance of the LED illuminator.

As described hereinbefore, the present invention provides a heat radiation substrate and an illumination module substrate having a hybrid layer. According to the present invention, the heat radiation substrate includes a hybrid layer formed of a thermoplastic resin, in particular, LCP, and thus can be lightweight and small thanks to the inherent properties of plastic, and also, mass production thereof is possible, thus reducing the material and process costs.

Furthermore, because the heat radiation substrate is manufactured in the form of a composite structure using thermoplastic LCP resin mixed with a filler or fiber having high thermal conductivity, heat radiation performance can be improved and chemical resistance can be enhanced, thus improving processability.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A heat radiation substrate having a hybrid layer, comprising:
a hybrid layer including a thermoplastic polymer and a conductive filler;
an insulating layer formed on the hybrid layer; and
a metal layer formed on the insulating layer.

2. The heat radiation substrate as set forth in claim 1, wherein the insulating layer comprises a thermoplastic polymer and a thermally conductive ceramic filler.

3. The heat radiation substrate as set forth in claim 1, wherein the thermoplastic polymer of the hybrid layer is any one selected from the group consisting of a liquid crystal polymer (LCP), polyetheretherketone (PEEK), polyetherimide (PEI), polyethersulfone (PES) and polytetrafluoroethylene (PTFE).

4. The heat radiation substrate as set forth in claim 1, wherein the conductive filler is one or more selected from the group consisting of a carbonaceous filler, metallic powder, a metal oxide-based filler and a conductive coating filler.

5. The heat radiation substrate as set forth in claim 1, further comprising a via for connecting the metal layer and the hybrid layer to each other.

6. The heat radiation substrate as set forth in claim 2, wherein the thermally conductive ceramic filler is crystalline silica (SiO₂), fused silica (SiO₂), silicon nitride (SiN), boron nitride (BN), aluminum nitride (AlN) or alumina (Al₂O₃), or is a heterogeneous mixture of fillers having different thermal conductivities and shapes.

7. The heat radiation substrate as set forth in claim 2, wherein the thermoplastic polymer of the insulating layer is any one selected from the group consisting of a liquid crystal polymer (LCP), polyetheretherketone (PEEK), polyetherimide (PEI), polyethersulfone (PES) and polytetrafluoroethylene (PTFE).

8. The heat radiation substrate as set forth in claim 2, wherein the insulating layer is a prepreg formed by impregnating a woven fabric with a liquid crystal polymer (LCP) resin, as the thermoplastic polymer, containing the thermally conductive ceramic filler.

9. The heat radiation substrate as set forth in claim 4, wherein the carbonaceous filler is carbon black, graphite powder, carbon fiber or carbon nanotubes.

10. The heat radiation substrate as set forth in claim 4, wherein the metallic powder is gold, silver, platinum, copper, or aluminum powder.

11. The heat radiation substrate as set forth in claim 8, wherein the woven fabric is E-glass, D-glass, S-glass or aramid fiber.

12. An illumination module substrate having a hybrid layer, comprising:
a hybrid layer including a thermoplastic polymer and a conductive filler;
an insulating layer formed on the hybrid layer; and
a metal layer formed on the insulating layer.
